(19) United States
(12) Patent Application Publication
(10) Pub. No.: US 2012/0275182 A1
(43) Pub. Date: Nov. 1, 2012

(54) LED BACKLIGHT MODULE HAVING EXTRUSION HOUSING

(75) Inventor: Tsan-Jung Chen, New Taipei City (TW)

(73) Assignee: KOCAM INTERNATIONAL CO., LTD., New Taipei City (TW)

(21) Appl. No.: 13/364,317

(22) Filed: Feb. 1, 2012

(30) Foreign Application Priority Data
Apr. 29, 2011 (TW) 100206034

(51) Int. Cl. G09F 13/04

(52) U.S. Cl. 362/602

(57) ABSTRACT

The present invention relates to an LED backlight module having extrusion housing, comprising: an extrusion housing, a circuit layer, a thermal conductive band, an accommodating body, a plurality of LED chips, a first elastic thermal-conductive member, and second elastic thermal-conductive member, wherein the accommodating body has a plurality of through holes for receiving the LED chips, such that the LED chips disposed on the circuit layer can pass through the through holes, respectively, therefore, the LED chips accommodated in the through holes are protected from suffering the impact caused by an external force; Moreover, through the thermal conductive band, the first elastic thermal-conductive member and the second elastic thermal-conductive member, when the LED chips emit light, the heat produced by the LED chips can be effectively dissipated via “double-direction dissipation”, that is, the heat can be dissipated via the front surface and the rear surface of the circuit layer.

### BACKGROUND OF THE INVENTION

1. Technical Field

The present invention relates to an LED backlight module, and more particularly, to an LED backlight module having extrusion housing for protecting LED chips from suffering the impact caused by an external force.

2. Description of Related Art

LCD display is the most widely used display product, which is able to exactly show images by way of using a liquid crystal layer of a liquid crystal panel to control the light transmittance of the location of each pixel. Currently, the LCD display are massively applied in TV, mobile phone, smart phone, notebook, and personal digital assistant (PDA). However, since the liquid crystal panel is a non-self-luminous material, the LCD display must to be included a backlight module for providing the liquid crystal panel with a light source.

Please refer to FIG. 1, which illustrates a schematic combination diagram of a conventional LED backlight module installed in a liquid crystal display. As shown in FIG. 1, the conventional LED backlight module includes: a main frame 100′ and at least one light bar 200′, wherein the main frame 100′ has a bottom plate 110′ and four edge (120′, 140′, 160′, 180′) and the light bar 200′ is disposed on the edges (120′, 140′, 180′) through a thermal conductive adhesion. The light bar 200′ consists of a plurality LED chips 210′ and a printed circuit board 220′. In addition, a light guide plate 300′ is installed in the main frame 100′, wherein the light guide plate 300′ includes four protrusions 350′ for being embedded into the four edges (120′, 140′, 160′, 180′).

In the aforesaid LED backlight module, the light bar 200′ is directly disposed in the main frame without using any protecting housing, so that, the LED chip 210′ and the light bar 200′ may suffer damages when the liquid crystal display is moving and collided. Accordingly, for solving this problem, LED backlight module manufacturers propose an LED backlight module with housing. Please refer to FIG. 2, there is shown a schematic combination diagram of the LED backlight module with housing installed in a liquid crystal display. As shown in FIG. 2, two backlight modules 12″ are oppositely installed on the two edges of the main frame 11′ installed in the liquid crystal display, and each the backlight module 12″ includes:

a housing 121″, a printed circuit board 122″ and a plurality of LED chips 123″.

General speaking, the housing 121″ is made of a sheet metal and the appearance thereof is [symbol] -shape or L-shape. The printed circuit board 122″ is disposed on the housing 121″ and the LED chips 123″ is welded on the printed circuit board 122″. Moreover, for increasing the backlight efficiency, a reflecting layer (not shown) is attached to the inner surface of the housing 121″, therefore, the light emitted from the LED chips 123″ may nearly received by the light guide plate.

In the above-mentioned LED backlight module with housing, the housing 121″ is used for accommodating the LED chips 123″ and the printed circuit board 122″, so as to protect the LED chips 123″ from suffering the impact caused by an external force. However, for the above-mentioned LED backlight module with housing, the LED chips 123″ and the printed circuit board 122″ may still suffer damages when the liquid crystal display is moving and collided. The reason is that the housing 121″ is made by the thin sheet metal, so that, when the liquid crystal display is collided, the thin sheet metal would be twisted by the collision force.

So that, through above descriptions, it is able to know the conventional LED backlight module and the LED backlight module with housing still have shortcomings and drawbacks; Accordingly, the inventor of the present application has made great efforts to make inventive research thereon and eventually provided an LED backlight module having extrusion housing.

### BRIEF SUMMARY OF THE INVENTION

The first objective of the present invention is to provide an LED backlight module having extrusion housing, in which, an accommodating body is disposed in an extrusion housing, then the LED chips disposed on the circuit layer can pass through the through holes of the accommodating body, therefore, the LED chips accommodated and fixed in the through holes are protected from suffering the impact caused by an external force.

The second objective of the present invention is to provide an LED backlight module having extrusion housing, in which, an accommodating body is disposed in an extrusion housing, then the LED chips disposed on the circuit layer can pass through the through holes of the accommodating body, moreover, through a thermal conductive band, a first elastic thermal-conductive member and a second elastic thermal-conductive member, when the LED chips emit light, the heat produced by the LED chips can be effectively dissipated via “double-direction dissipation”, that is, the heat can be dissipated via the front surface and the rear surface of the circuit layer.

Accordingly, to achieve the above first and second objectives of the present invention, the inventor proposes an LED backlight module having extrusion housing, capable of being disposed in a main frame of a liquid crystal display, wherein the main frame has a bottom plate and at least one edge, and the LED backlight module having extrusion housing comprising:

an extrusion housing, disposed on the edge of the main frame, wherein the extrusion housing is made of metal and the surface thereof is processed a surface treatment process, moreover, the extrusion housing has a disposing portion, two protrusion portions and a bottom portion, in which, the disposing portion is connected to the bottom portion and the two protrusion portions are formed on the bottom portion, moreover, both the disposing portion and the bottom portion having a specific thickness;

a circuit layer, printed on the surfaces of the disposing portion and one of the two protrusion portions;

a thermal conductive band, disposed on the protrusion portions and the bottom portion, and extendedly disposed on the bottom plate of the main frame;

an accommodating body, disposed on the disposing portion, and having an accommodating groove and a plurality of through holes opposite to the accommodating groove, wherein a light guide plate is accommodated in the accommodating groove by a light-receiving surface thereof;

a plurality of LED chips, disposed on the circuit layer and respectively passing through the through holes for emitting light to the light-receiving surface of the light guide plate;

a first elastic thermal-conductive member, being disposed in a first groove formed on the outer surface of the disposing portion; and

a second elastic thermal-conductive member, disposed in a second groove formed on the outer surface of the bottom portion;

wherein each of the through holes have a specific depth, therefore, the LED chips are buried in the through holes when the LED chips are disposed on the circuit layer and respectively pass through the through holes;

wherein when the LED chips emit the light, the circuit layer printed on the surfaces of the disposing portion and one of the two protrusion portions conducts the heat produced by the LED chips to the thermal conductive band, and then the thermal conductive band further conducts the heat to the bottom plate for evenly distribute the heat on the bottom plate; moreover, through the first elastic thermal-conductive member and the second elastic thermal-conductive member, the heat can also be simultaneously conducted to the edge and the bottom plate of the main frame, furthermore, the heat may be dissipated to the air via the main frame.

The third objective of the present invention is to provide an LED backlight module having extrusion housing, in which, a spacing member with a plurality of holes is disposed in an extrusion housing, therefore the LED chips disposed on the circuit layer can be received and fixed by the holes of the spacing member when the LED chips is accommodated by the extrusion housing, then the LED chips are protected from suffering the impact caused by an external force.

So that, to achieve the above third objective of the present invention, the inventor proposes an LED backlight module having extrusion housing, capable of being disposed in a main frame of a liquid crystal display, wherein the main frame has a bottom plate and at least one edge, and the LED backlight module having extrusion housing comprising:

an extrusion housing, disposed on the edge of the main frame, wherein the extrusion housing is made of metal and the surface thereof is processed a surface treatment process, moreover, the extrusion housing having a disposing portion, two protrusion portions and a bottom portion, in which, the disposing portion is connected to the bottom portion and the two protrusion portions are formed on the bottom portion, moreover, both the disposing portion and the bottom portion have a specific thickness;

a circuit layer, printed on the surfaces of the disposing portion;

a thermally conductive insulating layer, attached to the surface of the circuit layer and extendedly attached to the inner surface of the extrusion housing, wherein the thermally conductive insulating layer has a plurality of first holes;

a reflector, disposed on the disposing portion opposite to the circuit layer and having a plurality of second holes, where a first surface of the reflector is printed with a thermal conductive adhesive;

a spacing member, disposed on a second surface of the reflector and having a plurality of third holes opposite to the second holes;

a plurality of LED chips, disposed on the circuit layer and sequentially passing through the third holes, the second holes and the first holes for emitting light to a light-receiving surface of a light guide plate; and

a thermal conductive layer, made of metal and disposed in the outer surface of the extrusion housing, wherein one end of the thermal conductive layer formed with a thermal conductive tassel, used for being attached to the bottom plate as the extrusion housing is disposed in the main frame;

wherein the spacing member has a specific thickness, therefore, the LED chips are buried in the third holes when the LED chips are disposed on the circuit layer and sequentially passing through the third holes, the second holes and the first holes;

wherein when the LED chips emit the light, the circuit layer conducts the heat produced by the LED chips to the thermally conductive insulating layer and the disposing portion, and then the thermally conductive insulating layer and the disposing portion further conduct the heat to the extrusion housing, so as to conduct the heat to the main frame, moreover, the thermal conductive tassel of the thermal conductive layer may evenly distribute the heat on the bottom plate.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a schematic combination diagram of a conventional LED backlight module installed in a liquid crystal display;

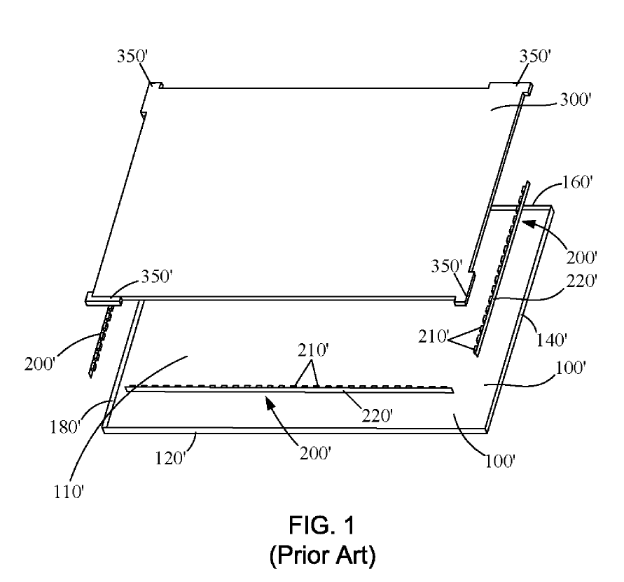

FIG. 2 is a schematic combination diagram of an LED backlight module with housing installed in a liquid crystal display;

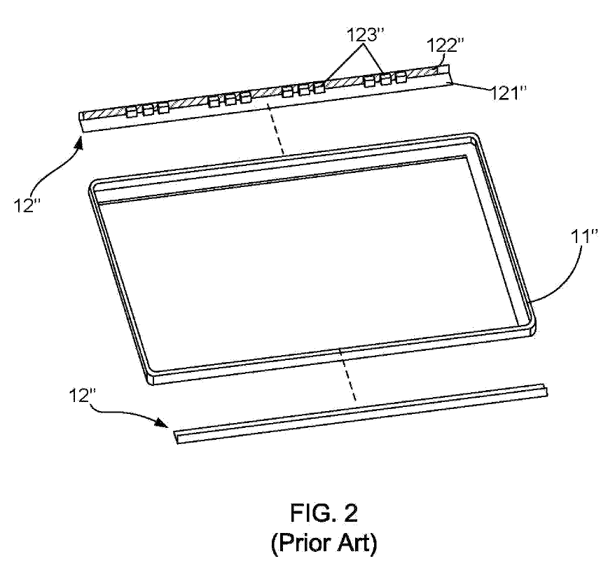

FIG. 3 is a stereo exploded view of a first embodiment of an LED backlight module having extrusion housing according to the present invention;

FIG. 4A is a side view of the first embodiment of the LED backlight module having extrusion housing according to the present invention;

FIG. 4B is a second side view of the first embodiment of the LED backlight module having extrusion housing according to the present invention;

FIG. 5 is a stereo exploded view of a second embodiment of the LED backlight module having extrusion housing according to the present invention;

FIG. 6 is a side view of the second embodiment of the LED backlight module having extrusion housing according to the present invention;

FIG. 7A is a side view of a third embodiment of the LED backlight module having extrusion housing according to the present invention;

FIG. 7B is a second side view of the third embodiment of the LED backlight module having extrusion housing according to the present invention;

FIG. 8A is a side view of a fourth embodiment of the LED backlight module having extrusion housing according to the present invention; and

FIG. 8B is a second side view of the fourth embodiment of the LED backlight module having extrusion housing according to the present invention.

### DETAILED DESCRIPTION OF THE INVENTION

To more clearly describe an LED backlight module having extrusion housing according to the present invention, embodiments of the present invention will be described in detail with reference to the attached drawings hereinafter.

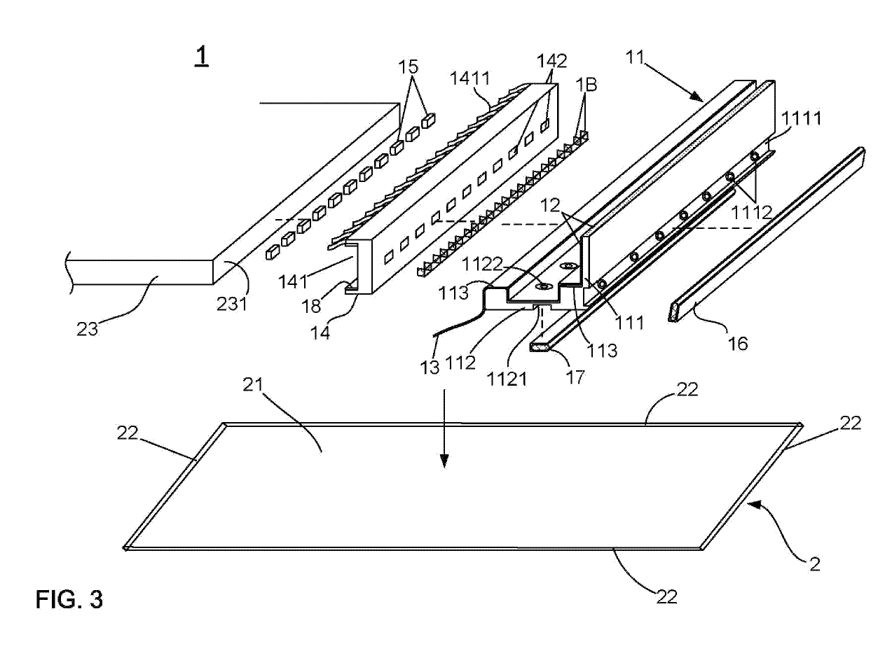

Please refer to FIG. 3, which illustrates a stereo exploded view of a first embodiment of an LED backlight module having extrusion housing according to the present invention. As shown in FIG. 3, for the first embodiment of the LED backlight module 1 having extrusion housing, the LED backlight module 1 is capable of being disposed in a main frame 2 of a liquid crystal display, wherein the main frame 2 has a bottom plate 21 and at least one edge 22, and the LED backlight module 1 includes: an extrusion housing 11, a circuit layer 12, a thermal conductive band 13, an accommodating body 14, a plurality of LED chips 15, a first elastic thermal-conductive member 16, and a second elastic thermal-conductive member 17.

The material of the extrusion housing 11 may be copper, aluminum, electro-galvanized steel sheet, or hot-dipped galvanized steel sheet. The extrusion housing 11 is disposed on the edge 22 of the main frame 2, and the surface of the extrusion housing 11 is processed a surface treatment process, moreover, the extrusion housing 11 has a disposing portion 111, two protrusion portions 113 and a bottom portion 112; In which, the disposing portion 111 is connected to the bottom portion 112 and the two protrusion portions 113 are formed on the bottom portion 112, moreover, both the disposing portion 111 and the bottom portion 112 have a specific thickness.

The circuit layer 12 is printed on the surfaces of the disposing portion 111 and one of the two protrusion portions 113 by way of printing, lithography and etching. For this reason, the surface of the extrusion housing 11 needs to be processed an anode treatment or a film coating treatment before printing the circuit layer 12 on the surfaces of the disposing portion 111 and the protrusion portion 113. Therefore, the surfaces of the disposing portion 111 and the protrusion portion 113 are protected from corrosion when the printing, the lithography or the etching is executed, and then the circuit layer 12 with large area is formed on the surface of the disposing portion 111 and the protrusion portion 113.

The thermal conductive band 13 is disposed on the protrusion portions 113 and the bottom portion 112, and extendedly disposed on the bottom plate 21 of the main frame 2. The accommodating body 14 can be a metal body, a reflective body, and a combined body consisting of the metal body and the reflective body. As shown in FIG. 3, the accommodating body 14 is disposed on the disposing portion 111 of the extrusion housing 11, and has an accommodating groove 141 and a plurality of through holes 142 opposite to the accommodating groove 141, wherein a light guide plate 23 is accommodated in the accommodating groove 141 by a light-receiving surface 231 thereof.

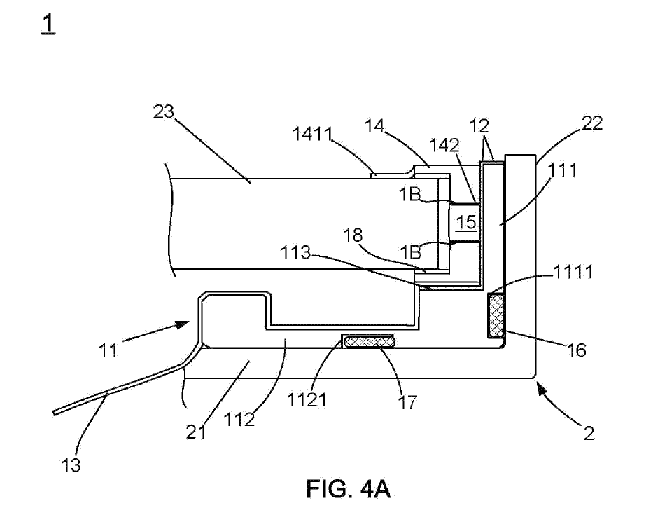

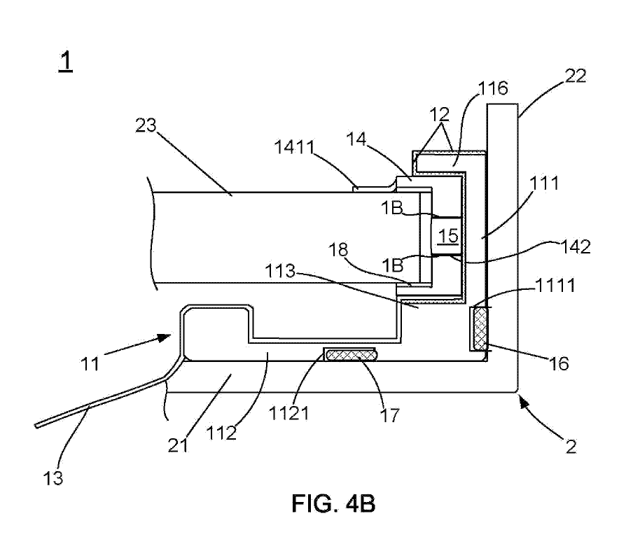

Referring to FIG. 3 again, and please refer to FIG. 4A, there is shown a side view of the first embodiment of the LED backlight module having extrusion housing according to the present invention. As shown in FIG. 3 and FIG. 4A, the LED chips 15 are disposed on the circuit layer 12 and respectively pass through the through holes 142; Herein, the LED chip 15 can be a direct type LED chip or an edge type LED chip, and the LED chips 15 can emit light to the light-receiving surface 231 of the light guide plate 23. In addition, one end of the accommodating body 14 is formed with a tassel portion 1411, and the tassel portion 1411 is used for being tightly attached to the light guide plate 23 when the light guide plate 23 is accommodated by the accommodating body 14, such that the light emitted by the LED chips 15 would not leak via the gap formed between the accommodating groove 141 and the light guide plate 23.

The first elastic thermal-conductive member 16 is disposed in a first groove 1111 formed on the outer surface of the disposing portion 111. In the first embodiment of the LED backlight module 1 having extrusion housing, the first elastic thermal-conductive member 16 is cut in to plural segments for increasing the elasticity and flexibility thereof, moreover, a thin metal layer with high thermal conductivity is covered with the surface of the first elastic thermal-conductive member 16. Besides, the second elastic thermal-conductive member 17 is disposed in a second groove 1121 formed on the outer surface of the bottom portion 112; Moreover, the same to the first elastic thermal-conductive member 16, the second elastic thermal-conductive member 17 is cut in to plural segments for increasing the elasticity and flexibility, and a thin metal layer with high thermal conductivity is covered with the surface of the second elastic thermal-conductive member 17.

As shown in FIG. 4A, each of the through holes 142 have a specific depth, therefore, the LED chips 15 are buried in the through holes 142 when the LED chips 15 are disposed on the circuit layer 12 and respectively pass through the through holes 142. Moreover, when the LED chips 15 emit the light, the circuit layer 12 printed on the surfaces of the disposing portion 111 and the protrusion portion 113 conducts the heat produced by the LED chips 15 to the thermal conductive band 13, and then the thermal conductive band 13 further conducts the heat to the bottom plate 21 for evenly distribute the heat on the bottom plate 21; Besides, through the first elastic thermal-conductive member 16 and the second elastic thermal-conductive member 17, the heat can also be simultaneously conducted to the edge 22 and the bottom plate 21 of the main frame 2, furthermore, the heat may be dissipated to the air via the main frame 2.

Furthermore, as shown in FIG. 3, a plurality of first threaded holes 1112 and second threaded holes 1122 are formed on the first groove 1111 of the disposing portion 111 and the second groove 1121 of the bottom portion 112, respectively, used for securing the extrusion housing 11 on the edge 22 and the bottom plate 21 of the main frame 2. In addition, as shown in FIG. 3 and FIG. 4A, for increasing the backlight efficiency of the LED backlight module 1, a reflecting layer 18/a white paint can be disposed/painted in the accommodating body 14, wherein the reflecting layer 18 is formed by a reflector.

Besides, for preventing from short circuit, a plurality of insulating members 1B are respectively disposed in the inner walls of the through holes 142, wherein when the LED chips 15 are disposed and welding on the circuit layer 12, the insulating members 1B may prevent the welding solder from diffusing into the through holes 142, so as to avoid the short circuit. Furthermore, please refer to FIG. 4B, there is shown a second side view of the first embodiment of the LED backlight module having extrusion housing according to the present invention. For increasing the circuit area, as shown in FIG. 4B, an extension portion 116 is formed on the disposing portion 111, wherein the circuit layer 12 can also be printed on the surface of the extension portion 116 for expending the circuit area.

Therefore, the above descriptions have been clearly and completely introduced the first embodiment of the LED backlight module 1 having extrusion housing of the present invention; in summary, the first embodiment of the LED backlight module 1 has the following advantages:

1. In first embodiment of the LED backlight module having extrusion housing of the present invention, it utilizes the extrusion housing 11 and the accommodating body 14 to accommodate the LED chips 15 and the light guide plate 23, so that, the LED chips 15 accommodated in the through holes are protected from suffering the impact caused by an external force.
2. Inheriting to above point 1, moreover, the LED chips 15 are buried in the through holes 142 of the accommodating body 14, such that the LED backlight module 1 performs a good backlight quality because the LED chips 15 are fixed and limited in the through holes 142.
3. Inheriting to above point 2, the through holes 142 of the accommodating body 14 are also used for positioning the LED chips 15 on the circuit layer 12.
4. In first embodiment of the LED backlight module having extrusion housing of the present invention, through the thermal conductive band, the first elastic thermal-conductive member and the second elastic thermal-conductive member, when the LED chips emit light, the heat produced by the LED chips can be effectively dissipated via “double-direction dissipation”, that is, the heat can be dissipated via the front surface and the rear surface of the circuit layer.
5. Differing from the conventional LED backlight module, in the first embodiment of the LED backlight module having extrusion housing of the present invention, the circuit layer 12 is printed on the surface of the extrusion housing 11 by way of printing, lithography and etching.
6. In addition, an extension portion 116 can further be formed on the disposing portion 111 of the extrusion housing 11, therefore the circuit layer 12 can also be printed on the surface of the extension portion 116 for expending the circuit area.

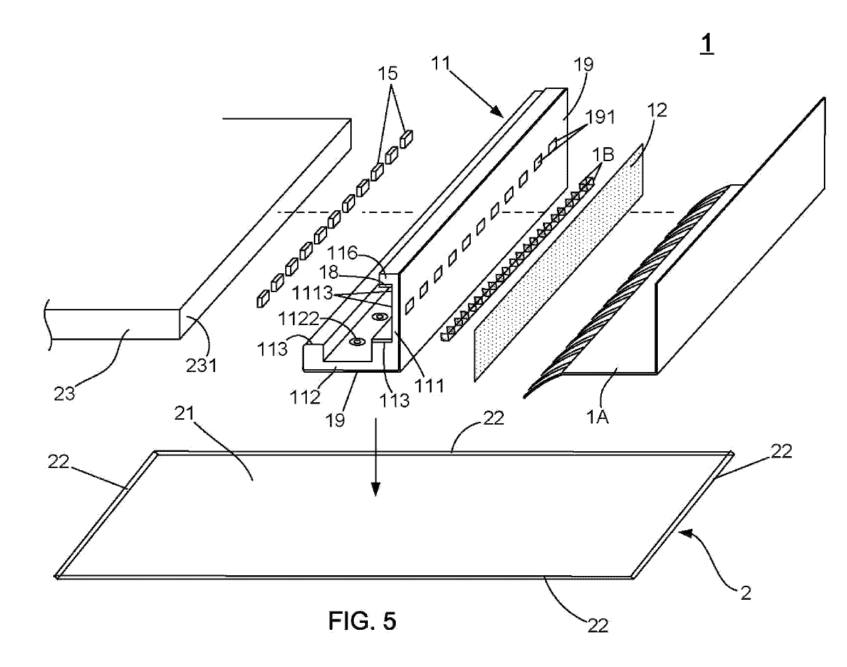

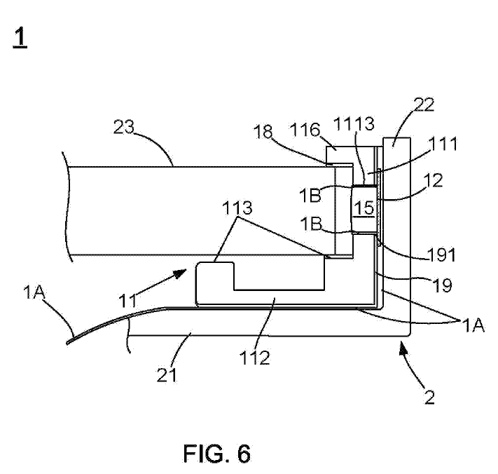

In the present invention, it further provides a second embodiment for the backlight module having extrusion housing. Please refer to FIG. 5 and FIG. 6, there are shown a stereo exploded view and a side view of the second embodiment of the LED backlight module having extrusion housing according to the present invention. As shown in FIG. 5 and FIG. 6, the second embodiment of the LED backlight module 1 includes: an extrusion housing 11, a first thermal conductive band 19, a circuit layer 12, a plurality of LED chips 15, and a second thermal conductive band 1A.

The extrusion housing 11 is disposed on the edge 22 of the main frame 2 and having a disposing portion 111, two protrusion portions 113, a bottom portion 112, and an extension portion 116, wherein the disposing portion 111 is connected to the bottom portion 112 and has a plurality of first openings 1113, the two protrusion portions 113 are formed on the bottom portion 112, and the extension portion 116 is formed on one end of the disposing portion 111 opposite to one of the two protrusion portions 113, moreover, both the disposing portion 111 and the bottom portion 112 have a specific thickness.

The first thermal conductive band 19 is a thermally conductive insulating adhesion, which is simultaneously attached to the outer surfaces of the disposing portion 111 and the bottom portion 112 of the housing 11, and has a plurality of second openings 191 respectively opposite to the first openings 1113. The circuit layer 12 is disposed on the first thermal conductive band 19, and the LED chips 15, are disposed on the circuit layer 12 and pass through the first openings 1113 and the second openings 191, respectively. In which, a light guide plate 23 is embedded into an accommodating space formed by the extension portion 116 and one of the two protrusion portions 113, and the LED chips 15 can emit light to a light-receiving surface 231 of the light guide plate 23. The second thermal conductive band 1A is made of metal and attached to the surface of the circuit layer 12, moreover, the end part of the second thermal conductive band 1A is extended to the bottom plate 21 of the main frame 2 and formed to tassel shape.

In the second embodiment of the LED backlight module 1, as shown in FIG. 6, each of the first openings 1113 have a specific depth, therefore, the LED chips 15 are buried in the first openings 1113 when the LED chips 15 are disposed on the circuit layer 12 and respectively pass through the first openings 1113. Moreover, when the LED chips 15 emit the light, the circuit layer 12 conducts the heat produced by the LED chips 15 to the first thermal conductive band 19 and the second thermal conductive band 1A, and then the first thermal conductive band 19 further conducts the heat to the disposing portion 111 and the bottom portion 112 of the housing 11, and the second thermal conductive band 1A conducts the heat to the bottom plate 21 of the main frame 2, therefore, the disposing portion 111 and the bottom portion 112 conduct the heat to the edge 22 and the bottom plate 21 of the main frame 2 for dissipating to the air, moreover, the end tassel of the second thermal conductive band 1A may evenly distribute the heat on the bottom plate 21.

Similarly, for increasing the backlight efficiency of the LED backlight module 1, as shown in FIG. 5 and FIG. 6, a reflecting layer 18 is disposed in the accommodating space; Besides, a plurality of threaded holes 1122 are formed on the groove between the two protrusion portions 113.

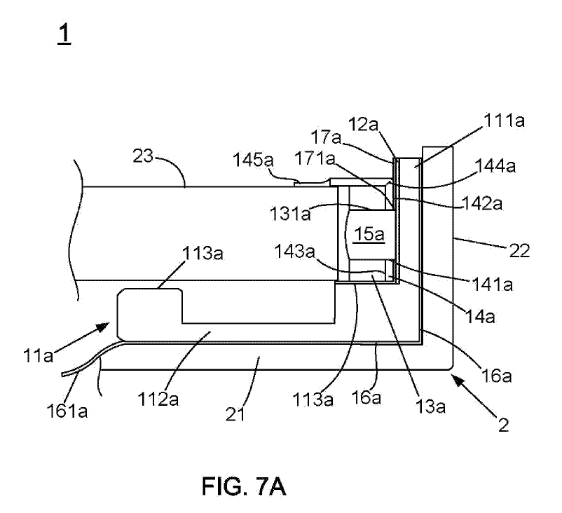

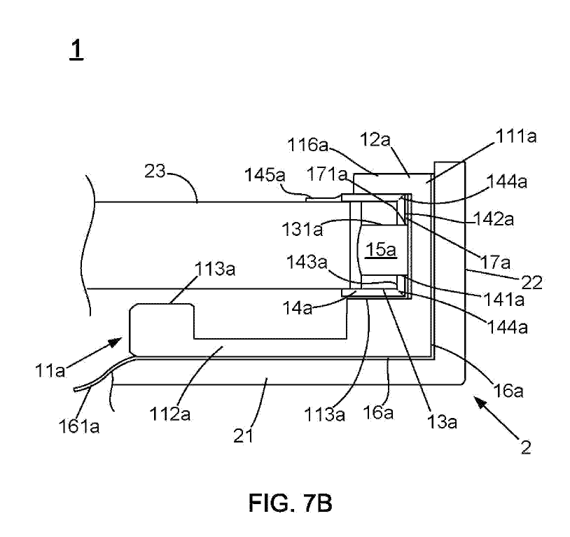

Furthermore, the present invention also provides a third embodiment for the LED backlight module having extrusion housing. Please refer to FIG. 7A, which illustrates a side view of the third embodiment of the LED backlight module having extrusion housing according to the present invention. As shown in FIG. 7A, the third embodiment of the LED backlight module 1 includes: an extrusion housing 11a, a circuit layer 12a, a thermally conductive insulating layer 17a, a reflector 14a, a spacing member 13a, a plurality of LED chips 15, and a thermal conductive layer 16a.

The extrusion housing 11a is disposed on the edge 22 of the main frame 2, wherein the extrusion housing 11a is made of metal and the surface thereof is processed a surface treatment process, moreover, the extrusion housing 11a has a disposing portion 111a, two protrusion portions 113a and a bottom portion 112a; in which, the disposing portion 111a is connected to the bottom portion 112a and the two protrusion portions 113a are formed on the bottom portion 112a, moreover, both the disposing portion 111a and the bottom portion 112a have a specific thickness.

The circuit layer 12a is printed on the surfaces of the disposing portion 111a, and the thermally conductive insulating layer 17a is attached to the surface of the circuit layer 12a and extendedly attached to the inner surface of the extrusion housing 11a, wherein the thermally conductive insulating layer 17a has a plurality of first holes 171a. The reflector 14a includes at least one cut mark 144a and a reflector tassel 145a, and the cut mark 144a is used for bending the reflector 14a to an accommodating body, for example, a L-shaped accommodating body for accommodating a light guide plate 23. As shown in FIG. 7A, the reflector 14a is disposed on the disposing portion 111a opposite to the circuit layer 12a and has a plurality of second holes 141a, where a first surface 142a of the reflector 14a is printed with a thermal conductive adhesive. In addition, the spacing member 13a is disposed on a second surface 143a of the reflector 14a and has a plurality of third holes 131a opposite to the second holes 141a.

The plurality of LED chips 15 are disposed on the circuit layer 12 and sequentially pass through the third holes 131a, the second holes 141a and the first holes 171a for emitting light to a light-receiving surface 231 of a light guide plate 23. Moreover, the reflector tassel 145a is used for tightly attached to the light guide plate 23 when the light guide plate 23 is inserted into the accommodating body formed by the reflector 14a, and the thermal conductive layer 16a is disposed in the outer surface of the extrusion housing 11, wherein one end of the thermal conductive layer 16a formed with a thermal conductive tassel 161a, used for being attached to the bottom plate 21 as the extrusion housing 11a is disposed in the main frame 2.

In the aforesaid third embodiment, wherein the spacing member 13a has a specific thickness, therefore, the LED chips 15 are buried in the third holes 131a when the LED chips 15 are disposed on the circuit layer 12 and sequentially passing through the third holes 131a, the second holes 141a and the first holes 171a. Moreover, when the LED chips 15a emit the light, the circuit layer 12a conducts the heat produced by the LED chips 15a to the thermally conductive insulating layer 17a and the disposing portion 111a, and then the thermally conductive insulating layer 17a and the disposing portion 111a further conduct the heat to the extrusion housing 11a, so as to conduct the heat to the main frame 2, moreover, the thermal conductive tassel 161a of the thermal conductive layer 16a may evenly distribute the heat on the bottom plate 21.

In addition, for easy to assemble, it can bend the reflector 14a to a [symbol] -shaped accommodating body by way of the cut mark 144a. Besides, as shown in FIG. 7B, there is shown a second side view of the third embodiment of the LED backlight module having extrusion housing according to the present invention. In FIG. 7B, an extension portion 116a can further formed on the disposing portion 111a of the extrusion housing 11a.

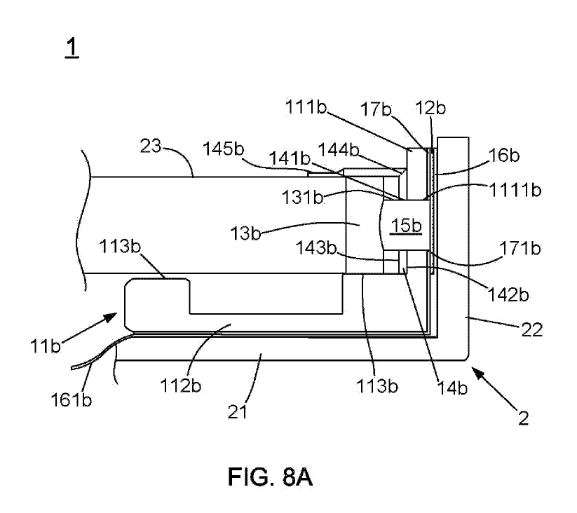

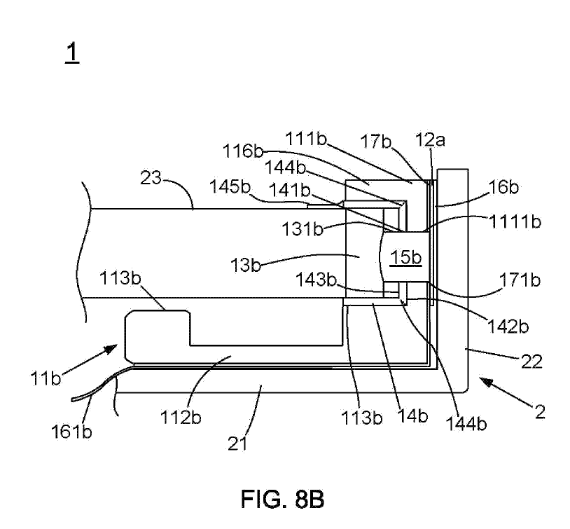

Finally, the present invention further provides a fourth embodiment for the LED backlight module having extrusion housing. Please refer to FIG. 8A and FIG. 8B, there are shown a side view and a second side view of the fourth embodiment of the LED backlight module having extrusion housing according to the present invention. As shown in FIG. 8A and FIG. 8B, the fourth embodiment of the LED backlight module 1 includes: an extrusion housing 11b, an extrusion housing 11b, a circuit layer 12b, a reflector 14b, a spacing member 13b, a plurality of LED chips 15b, and a thermal conductive layer 16b.

The extrusion housing 11b is disposed on the edge 22 of the main frame 2 and has a disposing portion 111b, two protrusion portions 113b and a bottom portion 112b, wherein the disposing portion 111b is connected to the bottom portion 112b and has a plurality of first openings 1111b, and the two protrusion portions 113b are formed on the bottom portion 112b, moreover, both the disposing portion 111b and the bottom portion 112b have a specific thickness.

The thermally conductive insulating layer 17b is attached to the surface of the circuit layer 12a and extendedly attached to the outer surface of the extrusion housing 11b and having a plurality of second openings 171b, and the circuit layer 12b is disposed on the thermally conductive insulating layer 17b. The reflector 14b includes at least one cut mark 144b and a reflector tassel 145b, and the cut mark 144b is used for bending the reflector 14b to an accommodating body, for example, a L-shaped accommodating body for accommodating a light guide plate 23. As shown in FIG. 8A, the reflector 14b is disposed on disposed on the disposing portion 111b opposite to the circuit layer 12b and has a plurality of third openings 141b, where a first surface 142b of the reflector 14b is printed with a thermal conductive adhesive. The spacing member 13b is disposed on a second surface 143b of the reflector 14b and has a plurality of fourth openings 131b opposite to the third holes 141b.

The plurality of LED chips 15b are disposed on the circuit layer 12b and sequentially pass through the fourth openings 131b, the third openings 141b, the first openings 111b, and the second openings 171b for emitting light to a light-receiving surface 231 of a light guide plate 23. The thermal conductive layer 16b is disposed in the outer surface of the circuit layer 12b, wherein one end of the thermal conductive layer 16b formed with a thermal conductive tassel 161b, used for being attached to the bottom plate 21 as the extrusion housing 11b is disposed in the main frame 2.

In the fourth embodiment, the spacing member 13b has a specific thickness, therefore, the LED chips 15b are buried in the fourth openings 131b when the LED chips 15b are disposed on the circuit layer 12b and sequentially pass through the fourth openings 131b, the third openings 141b, the first openings 111b, and the second openings 171b; Moreover, when the LED chips 15b emit the light, the circuit layer 12b conducts the heat produced by the LED chips 15b to the thermally conductive insulating layer 17b and the extrusion housing 11b, so as to conduct the heat to the main frame 2, moreover, the thermal conductive tassel 161b of the thermal conductive layer 16b may evenly distribute the heat on the bottom plate 21.

In addition, the same to aforesaid third embodiment, in the fourth embodiment of the LED backlight module 1, for easy to assemble, it can bend the reflector 14b to a [symbol] -shaped accommodating body by way of the cut mark 144b. Besides, as shown in FIG. 8B, there is shown a second side view of the third embodiment of the LED backlight module having extrusion housing according to the present invention. In FIG. 8B, an extension portion 116b can further formed on the disposing portion 111b of the extrusion housing 11b.

Thus, the above descriptions are made on embodiments of the present invention. However, the embodiments are not intended to limit scope of the present invention, and all equivalent implementations or alterations within the spirit of the present invention still fall within the scope of the present invention.

1. An LED backlight module having extrusion housing, capable of being disposed in a main frame of a liquid crystal display, wherein the main frame has a bottom plate and at least one edge, and the LED backlight module having extrusion housing comprising:
an extrusion housing, being disposed on the edge of the main frame, wherein the extrusion housing is made of metal and the surface thereof is processed a surface treatment process, moreover, the extrusion housing having a disposing portion, two protrusion portions and a bottom portion, in which, the disposing portion being connected to the bottom portion and the two protrusion portions being formed on the bottom portion, moreover, both the disposing portion and the bottom portion having a specific thickness;
a circuit layer, being printed on the surfaces of the disposing portion and one of the two protrusion portions;
a thermal conductive band, being disposed on the protrusion portions and the bottom portion, and extendedly disposed on the bottom plate of the main frame;
an accommodating body, being disposed on the disposing portion, and having an accommodating groove and a plurality of through holes opposite to the accommodating groove, wherein a light guide plate is accommodated in the accommodating groove by a light-receiving surface thereof;
a plurality of LED chips, being disposed on the circuit layer and respectively passing through the through holes for emitting light to the light-receiving surface of the light guide plate;
a first elastic thermal-conductive member, being disposed in a first groove formed on the outer surface of the disposing portion; and
a second elastic thermal-conductive member, being disposed in a second groove formed on the outer surface of the bottom portion;
wherein each of the through holes have a specific depth, therefore, the LED chips being buried in the through holes when the LED chips are disposed on the circuit layer and respectively pass through the through holes;
wherein when the LED chips emit the light, the circuit layer printed on the surfaces of the disposing portion and one of the two protrusion portions conducting the heat produced by the LED chips to the thermal conductive band, and then the thermal conductive band further conducts the heat to the bottom plate for evenly distribute the heat on the bottom plate; moreover, through the first elastic thermal-conductive member and the second elastic thermal-conductive member, the heat can also be simultaneously conducted to the edge and the bottom plate of the main frame, furthermore, the heat may be dissipated to the air via the main frame.

2. The LED backlight module having extrusion housing of claim 1, wherein a plurality of first threaded holes and second threaded holes are formed on the first groove of the disposing portion and the second groove of the bottom portion, respectively, used for securing the extrusion housing on the edge and the bottom plate of the main frame.

3. The LED backlight module having extrusion housing of claim 1, wherein the first elastic thermal-conductive member is cut in to plural segments, moreover, a thin metal layer with high thermal conductivity being covered with the surface of the first elastic thermal-conductive member.

4. The LED backlight module having extrusion housing of claim 1, wherein the second elastic thermal-conductive member is cut in to plural segments, moreover, a thin metal layer with high thermal conductivity being covered with the surface of the second elastic thermal-conductive member.

5. The LED backlight module having extrusion housing of claim 1, further comprising:
a reflecting layer, being disposed in the accommodating body; and
a plurality of insulating members, being respectively disposed in the inner walls of the through holes, wherein when the LED chips are disposed and welding on the circuit layer, the insulating members may prevent the welding solder from diffusing into the through holes.

6. The LED backlight module having extrusion housing of claim 5, wherein the accommodating body is selected from the group consisting of: metal body, reflective body, and combined body consisting of the metal body and the reflective body.

7. The LED backlight module having extrusion housing of claim 6, wherein one end of the accommodating body is formed with a tassel portion, used for being tightly attached to the light guide plate when the light guide plate is accommodated by the accommodating body, such that the light emitted by the LED chips would not leak via the gap formed between the accommodating groove and the light guide plate.

8. The LED backlight module having extrusion housing of claim 1, wherein the extrusion housing further comprises an extension portion formed on the disposing portion, wherein the circuit layer can also be printed on the surface of the extension portion for expending the circuit area.

9. An LED backlight module 1 having extrusion housing, capable of being disposed in a main frame of a liquid crystal display, wherein the main frame has a bottom plate and at least one edge, and the LED backlight module having extrusion housing comprising:
an extrusion housing, being disposed on the edge of the main frame and having a disposing portion, two protrusion portions, a bottom portion, and an extension portion, wherein the disposing portion is connected to the bottom portion and has a plurality of first openings, the two protrusion portions being formed on the bottom portion, and the extension portion being formed on one end of the disposing portion opposite to one of the two protrusion portions, moreover, both the disposing portion and the bottom portion having a specific thickness;
a first thermal conductive band, being simultaneously attached to the outer surfaces of the disposing portion and the bottom portion of the housing, and having a plurality of second openings respectively opposite to the first openings;
a circuit layer, being disposed on the first thermal conductive band;
a plurality of LED chips, being disposed on the circuit layer and passing through the first openings and the second openings, respectively;
a light guide plate, being embedded into an accommodating space formed by the extension portion and one of the two protrusion portions, wherein the LED chips can emit light to a light-receiving surface of the light guide plate; and
a second thermal conductive band, being made of metal and attached to the surface of the circuit layer, moreover, the end part of the second thermal conductive band being extended to the bottom plate of the main frame and formed to tassel shape;
wherein each of the first openings have a specific depth, therefore, the LED chips being buried in the first openings when the LED chips are disposed on the circuit layer and respectively pass through the first openings;
wherein when the LED chips emit the light, the circuit layer conducting the heat produced by the LED chips to the first thermal conductive band and the second thermal conductive band, and then the first thermal conductive band further conducts the heat to the disposing portion and the bottom portion of the housing, and the second thermal conductive band conducting the heat to the bottom plate of the main frame, therefore, the disposing portion and the bottom portion conducting the heat to the edge and the bottom plate of the main frame for dissipating to the air, moreover, the end tassel of the second thermal conductive band may evenly distribute the heat on the bottom plate.

10. The LED backlight module having extrusion housing of claim 9, wherein a plurality of threaded holes are formed on the groove between the two protrusion portions.

11. The LED backlight module having extrusion housing of claim 9, further comprising:
a reflecting layer, being disposed in the accommodating space; and
a plurality of insulating members, being respectively disposed in the inner walls of the first openings, wherein when the LED chips are disposed and welding on the circuit layer, the insulating members may prevent the welding solder from diffusing into the first openings.

12. An LED backlight module 1 having extrusion housing, capable of being disposed in a main frame of a liquid crystal display, wherein the main frame has a bottom plate and at least one edge, and the LED backlight module having extrusion housing comprising:
an extrusion housing, being disposed on the edge of the main frame, wherein the extrusion housing is made of metal and the surface thereof is processed a surface treatment process, moreover, the extrusion housing having a disposing portion, two protrusion portions and a bottom portion, in which, the disposing portion being connected to the bottom portion and the two protrusion portions being formed on the bottom portion, moreover, both the disposing portion and the bottom portion having a specific thickness;
a circuit layer, being printed on the surfaces of the disposing portion;
a thermally conductive insulating layer, being attached to the surface of the circuit layer and extendedly attached to the inner surface of the extrusion housing, wherein the thermally conductive insulating layer has a plurality of first holes;
a reflector, being disposed on the disposing portion opposite to the circuit layer and having a plurality of second holes, where a first surface of the reflector is printed with a thermal conductive adhesive;
a spacing member, being disposed on a second surface of the reflector and having a plurality of third holes opposite to the second holes;
a plurality of LED chips, being disposed on the circuit layer and sequentially passing through the third holes, the second holes and the first holes for emitting light to a light-receiving surface of a light guide plate; and
a thermal conductive layer, being made of metal and disposed in the outer surface of the extrusion housing, wherein one end of the thermal conductive layer formed with a thermal conductive tassel, used for being attached to the bottom plate as the extrusion housing is disposed in the main frame;
wherein the spacing member has a specific thickness, therefore, the LED chips being buried in the third holes when the LED chips are disposed on the circuit layer and sequentially passing through the third holes, the second holes and the first holes;
wherein when the LED chips emit the light, the circuit layer conducting the heat produced by the LED chips to the thermally conductive insulating layer and the disposing portion, and then the thermally conductive insulating layer and the disposing portion further conduct the heat to the extrusion housing, so as to conduct the heat to the main frame, moreover, the thermal conductive tassel of the thermal conductive layer may evenly distribute the heat on the bottom plate.

13. The LED backlight module having extrusion housing of claim 12, wherein the reflector further comprises:
at least one cut mark, being used for bending the reflector to an accommodating body; and
a reflector tassel, being used for tightly attached to the light guide plate when the light guide plate is inserted into the accommodating body formed by the reflector.

14. The LED backlight module having extrusion housing of claim 12, wherein the extrusion housing further comprises an extension portion formed on the disposing portion.

15. An LED backlight module having extrusion housing, capable of being disposed in a main frame of a liquid crystal display, wherein the main frame has a bottom plate and at least one edge, and the LED backlight module having extrusion housing comprising:
an extrusion housing, being disposed on the edge of the main frame and having a disposing portion, two protrusion portions and a bottom portion, wherein the disposing portion is connected to the bottom portion and has a plurality of first openings, and the two protrusion portions being formed on the bottom portion, moreover, both the disposing portion and the bottom portion having a specific thickness;
a thermally conductive insulating layer, being attached to the surface of the circuit layer and extendedly attached to the outer surface of the extrusion housing and having a plurality of second openings;
a circuit layer, being disposed on the thermally conductive insulating layer;
a reflector, being disposed on the disposing portion opposite to the circuit layer and having a plurality of third openings, where a first surface of the reflector is printed with a thermal conductive adhesive;
a spacing member, being disposed on a second surface of the reflector and having a plurality of fourth openings opposite to the third holes;
a plurality of LED chips, being disposed on the circuit layer and sequentially passing through the fourth openings, the third openings, the first openings, and the second openings for emitting light to a light-receiving surface of a light guide plate; and
a thermal conductive layer, being made of metal and disposed in the outer surface of the circuit layer, wherein one end of the thermal conductive layer formed with a thermal conductive tassel, used for being attached to the bottom plate as the extrusion housing is disposed in the main frame;
wherein the spacing member has a specific thickness, therefore, the LED chips being buried in the fourth openings when the LED chips are disposed on the circuit layer and sequentially passing through the fourth openings, the third openings, the first openings, and the second openings;
wherein when the LED chips emit the light, the circuit layer conducting the heat produced by the LED chips to the thermally conductive insulating layer and the extrusion housing, so as to conduct the heat to the main frame, moreover, the thermal conductive tassel of the thermal conductive layer may evenly distribute the heat on the bottom plate.

16. The LED backlight module having extrusion housing of claim 15, wherein the reflector further comprises:
at least one cut mark, being used for bending the reflector to an accommodating body; and
a reflector tassel, being used for tightly attached to the light guide plate when the light guide plate is inserted into the accommodating body formed by the reflector.

17. The LED backlight module having extrusion housing of claim 15, wherein the extrusion housing further comprises an extension portion formed on the disposing portion.
